(19) United States
(12) Patent Application Publication
(10) Pub. No.: US 2006/0129703 A1
(43) Pub. Date: Jun. 15, 2006

(54) Data storage device and control method for power-save modes thereof

(75) Inventors: Hiroshi Oshikawa, Kanagawa (JP); Daisuke Kawamata, Kanagawa (JP); Hirofumi Saitoh, Kanagawa (JP); Tsuguaki Kowa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B. V., Amsterdam (NL)

(21) Appl. No.: 11/285,929

(22) Filed: Nov. 23, 2005

(30) Foreign Application Priority Data
Dec. 9, 2004 (JP) 2004-356652

(51) Int. Cl. G06F 3/00

(52) U.S. Cl. 710/14

(57) ABSTRACT

Embodiments of the invention realize a power-save mode which prevents reduction in performance of a data storage device. The HDD as an embodiment of the present invention, upon receiving a request for switching to a power-save mode (PMREQ) from the host, judges whether the serial interface should be switched to the power-save mode based on the execution status of the command. When the HDD has determined not to switch the serial interface to the power-save mode, the HDD transmits a negative response (PMNACK) to the host and keep the serial interface in the active mode. By denying switching to a power-save mode when data transfer is executed within a short period of time, etc., it is possible to prevent reduction in performance of the data storage device.

### CROSS-REFERENCES TO RELATED APPLICATIONS

This application claims priority from Japanese Patent Application No. JP 2004-356652, filed Dec. 9, 2004, the entire disclosure of which is incorporated herein by reference.

### BACKGROUND OF THE INVENTION

The present invention relates to a control method for power-save modes of a data storage device.

Devices using various types of media such as optical disks, magnetic tapes and semiconductor memories are known as data storage devices. Among them, hard disk drives (hereinafter referred to as “HDDs”) have become popular as storage devices for computers to such an extent that they are one type of the storage devices indispensable for today's computers. Further, not limited to computers, their application is widening more and more due to the superior characteristics with the advent of moving picture recording/reproducing devices, car navigation systems, removable memories for digital cameras and so on.

A magnetic disk used in a HDD has a plurality of tracks formed concentrically and each track is partitioned into a plurality of sectors. In each sector, sector address information and user data are stored. A head element accesses the desired sector in accordance with the sector address information, whereby it is possible to write and read data to and from the sector. A signal read by the head element from a magnetic disk in a data reading process is subjected to given signal processing such as waveform-shaping and a decoding process in a signal processing circuit and is then transmitted to a host. The transfer data from the host is similarly processed as stated above by the signal processing circuit and is then written on a magnetic disk.

For an interface to transmit data between the host and the HDD, protocols such as the SCSI interface and the ATA interface are used in general. In particular, the ATT interface is used for many computers from the viewpoint of improved interface functions and an economical cost. In addition, it is widely used as an interface for other types of storage devices such as an optical disk storage device. In request of improved recording density of recording media and improved performance, requirements for data transfer speed of ATA interfaces are becoming increasingly severe.

For the above-stated reasons, an ATA interface using serial data transmission has been proposed as a substitute for conventional transmission systems using parallel data transmission. The Serial ATA (SATA) Standard is being formulated by the Serial ATA Working Group and is stated in detail, for example, in the Specifications prepared by the Serial ATA Working Group. See “Serial ATA: High Speed Serialized ATA Attachment Revision 1.0a” [Retrieved on Sep. 23, 2004] The Internet <URL: http://www.sata-io.org/specifications.asp>(Non-Patent Document 1).

Meanwhile, to reduce consumption power in HDDs, various power management methods have been proposed. See Japanese Patent Laid-Open No. 2000-173152 (Patent Document 1). Typically, an HDD includes a plurality of power-save modes, and switching is made to a prescribed power-save mode according to the number of commands from the host in a given period of time. In addition, for the SATA, power-save modes for serial interface are proposed. For the power-save modes, two modes are proposed according to time required for resetting, that is, the Partial state having shorter reset time and the Slumber state having longer recovery time.

The SATA defines power-save modes for the serial interface, as stated above. However, the definition only specifies a reset time from a power-save mode, and it does not define any specific stop circuit, switching timing to a power-save mode, etc. It is therefore important to effectively control power-save modes for serial interface to prevent a decrease in performance arising from switching to a power-save mode.

### BRIEF SUMMARY OF THE INVENTION

The present invention has been made under the above-described background, and it is a feature of the present invention is to prevent a decrease in performance of data storage devices such as an HDD and an optical disc player arising from switching to a power-save mode.

A first aspect of the present invention is a control method of power-save modes of a data storage device, which control method includes the steps of: receiving a switching request to a power-save mode from a host; judging the execution status in a command execution sequence in responding to the above-stated switching request for the host; judging approval or disapproval of the request according to the command execution status thus judged; and transmitting the response thus determined to the host. With such method, it is possible to effectively prevent decrease in performance arising from switching to a power-save mode.

The present invention works effectively when the data storage device executes data transfer with the host through serial data transmission and allows a serial interface to be switched to a power-save mode independently of other circuits, wherein the switching request to the power-save mode is a switching request to a power-save mode of the serial interface. The serial interface consumes additional power for establishing a link with the host, and therefore, it is possible to decrease power consumption by independently switching the serial interface to a power-save mode. In addition, mode switching in the serial interface can be achieved within a short period of time, which contributes to reduce impacts to performance in a command execution sequence as well.

When the switching request is received in an execution sequence of a command not accompanying user data transfer, it is preferable to transmit to the host a response of disapproval to the switching request.

In an execution sequence of a read command accompanying transmission of user data to the host, when the switching request is received in a period of time from a point when the user data to be transmitted is stored in a buffer to a point when the user data is transmitted to the host, it is preferable to transmit to the host a response of disapproval to the switching request. With such an arrangement, it is possible to prevent delay in data transfer sessions with the host which are expected to be executed in a short time, thus enabling effective prevention of a decrease in performance. Further, when the switching request is received in a period of time from a point when the user data is transmitted and a point when an area adapted to store subsequent user data associating with the active read command is secured in the buffer, it is preferable to transmit a response approving the switching request to the host and make switching to a power-save mode. With such an arrangement, it is possible, in the command execution sequence, to reduce consumption power while preventing a decrease in performance.

When user data transfer has been ready with the host, it is preferred to transmit to the host a response of disapproval to the switching request. With such an arrangement, it is possible to prevent delay in data transfer sessions with the host which are executed in a short time, thus enabling effective prevention of a decrease in performance.

Alternatively, in an execution sequence of a write command which accompanies reception of user data from the host, when the switching request is received in a period of time from a point when an area adapted to store the user data to be received is secured in the buffer and a point when the user data is received from the host, it is preferable that the controller should determine disapproval to the switching request. With such an arrangement, it is possible to prevent delay in data transfer sessions with the host which are expected to be executed in a short time, thus enabling effective prevention of a decrease in performance.

A data storage device according to a second aspect of the present invention is a data storage device including: a receiver which is adapted to receive a switching request to a power-save mode from a host; a controller which judges execution status in a command execution sequence in responding to the switching request from the host and determines approval or disapproval of the switching request according to the command execution status thus judged; and a transmitter which transmits a response to the judgment to the host. With such an arrangement, it is possible to effectively prevent a decrease in performance arising from switching to a power-save mode.

The present invention works effectively in particular if the data storage device includes a serial interface which executes data transfer with the host through serial data transmission and which can be switched to a power-save mode independently of other circuits, wherein the switching request to the power-save mode is a switching request to a power-save mode of the serial interface.

In an execution sequence of a write command which accompanies reception of user data from the host, when the switching request is received in a period of time from a point when an area adapted to store the user data to be received is secured in the buffer and a point when the user data is received from the host, it is preferable that the controller should determine disapproval to the switching request. With such an arrangement, it is possible to prevent delay in data transfer sessions with the host which are expected to be executed in a short time, thus enabling effective prevention of a decrease in performance. Further, when the switching request is received in a period of time from a point when the user data is stored in the buffer and a point when an area adapted to store subsequent user data associating with the active read command is secured in the buffer, it is preferable that the controller should determine approval to the switching request. With such an arrangement, it is possible, in the command execution sequence, to reduce consumption power while preventing a decrease in performance.

A third aspect of the present invention is a data storage device which includes a mode for executing regular operations and power-save modes, the data storage device including: a controller which judges execution status in a command execution sequence after initiating the command execution and determines approval or disapproval of switching to a power-save mode according to the command execution status thus judged; and a communication interface with the host, which is switched to a power-save mode when the controller determines the approval for switching. With such an arrangement, it is possible to reduce consumption power and effectively prevent a decrease in performance arising from switching to a power-save mode.

It is preferable that the controller should judge execution status in a command execution sequence in responding to a switching request to a power-save mode from the host and determine approval or disapproval of the request for approval according to the command execution status thus judged, and further, the communication interface transmits a response associating with the determination to the host.

Further, it is preferable that, when the controller receives the switching request in an execution sequence of a command which does not accompany user data transfer, the controller should determine disapproval of the switching request.

Alternatively, in an execution sequence of a read command which accompanies transmission of user data to the host, when the switching request is received in a period of time from a point when the user data to be transmitted is stored in a buffer to a point when the user data is transmitted to the host, it is preferable that the controller should determine disapproval of the switching request. Further, when the switching request is received in a period of time from a point when the user data is transmitted to a point when an area adapted to store subsequent user data associating with the active read command is secured in the buffer, it is preferable that the controller should determine approval of the switching request and switch the communication interface to a power-save mode.

It is preferable that the communication interface should transmit a request for data transfer to the host in the execution sequence of a write command, and further, the controller should disapprove transmission of the switching request to a power-save mode to the host during a period of time from a point when the request is transmitted to a point when the controller receives data for the request from the host. With such an arrangement, it is possible to prevent delay in data transfer sessions with the host which are expected to be executed in a short time close timing, thus enabling effective prevention of a decrease in performance.

According to the present invention, it is possible to improve the power-save mode control of a data storage device.

### BRIEF DESCRIPTION OF THE DRAWINGS

FIG. 1 is a block diagram showing a schematic configuration of an HDD according to the present embodiment of the invention.

FIG. 2 is a block diagram showing a schematic configuration of part of circuits in the HDC/MPU according to the embodiment.

FIG. 3 is a flow chart showing a process associated with a request for switching to the power-save mode from a host according to the embodiment.

FIG. 4 is a sequence diagram showing a basic sequence of a PIO data-in command according to the embodiment.

FIG. 5 is a flow chart showing a process of the HDD in an execution sequence of the PIO data-in command according to the embodiment.

FIG. 6 is a sequence diagram showing a basic sequence of a PIO data-out command according to the embodiment.

FIG. 7 is a sequence diagram showing a process of the HDD in an execution sequence of the PIO data-out command according to the embodiment.

FIG. 8 is a sequence diagram showing a basic sequence of a Read DMA command according to the embodiment.

FIG. 9 is a flow chart showing a process of the HDD in an execution sequence of the Read DMA command according to the embodiment.

FIG. 10 is a sequence diagram showing a basic sequence of a Write DMA command according to the embodiment.

FIG. 11 is a flow chart showing a process of the HDD in an execution sequence of the Read DMA command according to the embodiment.

FIG. 12 a sequence diagram showing a basic sequence of a Read FPDMA command according to the embodiment.

FIG. 13 is a flow chart showing a process of the HDD in an execution sequence of the Read FPDMA command according to the embodiment.

FIG. 14 is a sequence diagram showing a basic sequence of a Write FPDMA command according to the embodiment.

FIG. 15 is a flow chart showing a process of the HDD in an execution sequence of the Write FPDMA command according to the embodiment.

FIG. 16 is a sequence diagram showing a basic sequence of a Non-data command according to the embodiment.

FIG. 17 is a flow chart showing a process of the HDD in an execution sequence of the Non-data command according to the embodiment.

### DETAILED DESCRIPTION OF THE INVENTION

Hereinafter, embodiments applicable to the present invention will be described. For clear explanation, descriptions hereunder and the drawings are partially omitted and simplified as appropriate. It should be noted that, in the drawings, the same reference numerals are given to the same components, and redundant descriptions thereof are omitted as required to clearly articulate the descriptions.

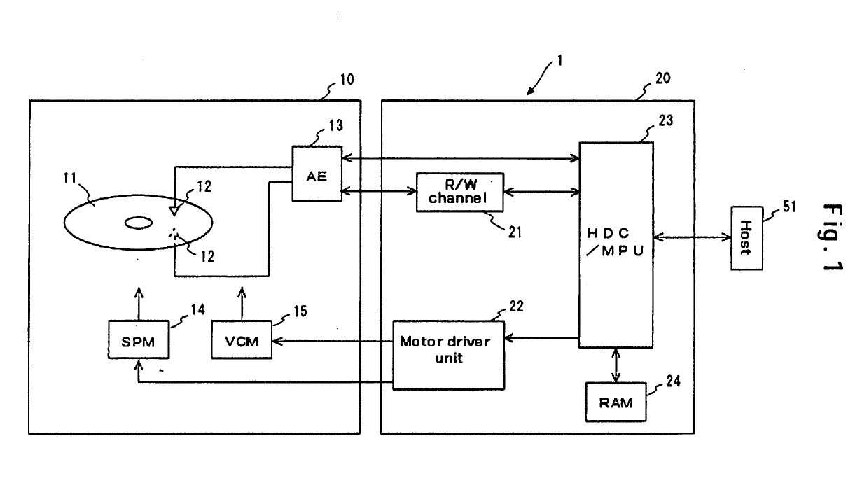

Hereinafter, specific embodiments to which the present invention is applied will be described in detail with reference to the accompanying drawings. To make the present invention more understandable, the outline of the overall configuration of a hard disk drive (HDD) which is an example of data storage devices will be described first. FIG. 1 is a block diagram showing a schematic configuration of an HDD 1 according to the embodiment. As shown in FIG. 1, the HDD 1 includes a magnetic disk 11 which is an example of recording media, a head element 12 which is an example of heads, an arm electronics (AE) 13, a spindle motor (SPM) 14 and a voice coil motor (VCM) 15 within a hermetically sealed enclosure 10.

The HDD I includes a circuit substrate 20 which is fixed on the outer side of the enclosure 10. On the circuit substrate 20, a read/write channel (R/W channel) 21, a motor driver unit 22, a hard disk controller (HDC)/MPU integrated circuit (hereinafter referred to as HDC/MPU) 23, and ICs including a RAM 24 as an example of memories. It should be noted that the circuit configurations can be integrated into one IC or can be mounted by being divided into a plurality of ICs.

Write data from an external host 51 is received by the HDC/MPU 23 and is written on the magnetic disk 11 by the head element 12 via the R/W channel 21 and the AE 13. Further, data stored on the magnetic disk 11 is read by the head element 12, and the data thus read is output to the external host 51 from the HDC/MPU 23 via the AE 13 and the R/W channel 21.

Next, the components of the HDD 1 will be each described. The magnetic disk 11 is fixed on the hub of the SPM 14. The SPM 14 rotates the magnetic disk 11 at a prescribed speed. The motor driver unit 22 drives the SPM 14 according to control data from the HDC/MPU 23. The magnetic disk 11 of the embodiment is provided on both sides thereof with recording surfaces on which data is recorded and the head elements 12 are provided which are associated with the respective recording surfaces.

The head elements 12 are fixed on respective sliders (not shown in the figure). Further, the slider is fixed on an actuator (now shown in the figure). The actuator includes the VCM 15, and the VCM 15, as being pivotally moved, moves the head element 12 along the radial direction over a magnetic disk 11. The motor driver unit 22 drives the VCM 15 according to control data from the HDC/MPU 23.

Typically, a write head which converts electric signals to magnetic fields according to data to be stored on the magnetic disk 11 and a read head which converts magnetic fields from the magnetic disk 11 to electric signals are formed on the head element 12 as an integral part. It should be noted that at least one magnetic disk 11 is sufficient to be prepared, and the recording surface can be formed on a single side or double sides of the magnetic disk 11.

Next, the circuits will be each described. The AE 13 selects one head element 12 among a plurality of head elements 12, which accesses data, amplifies a read signal to be read by the head element 12 thus selected at a constant gain (pre-amplifying) and sends the signal to the R/W channel 21. Further, the AE 13 sends a write signal from the R/W channel 21 to the selected head element 12.

The R/W channel 21 executes a write process on the data transmitted from the host 51. In the write process, the R/W channel 21 executes a code modulation on the write data supplied by the HDC/MPU 23 and further converts the code-modulated write data into a write signal (current), thereby supplying the signal to the AE 13. Further, when data is supplied to the host 51, the R/W channel 21 executes a read process. In the read process, the R/W channel 21 amplifies the read signal supplied from the AE 13 so as to be constant in amplitude, extracts data out of the read signal thus acquired, and executes a decoding process. The data to be read includes user data and servo data. The decoded read data is supplied to the HDC/MPU 23.

The HDC/MPU 23 is a circuit in which an MPU and an HDC are integrated into one chip. The MPU operates according to micro-codes loaded in the RAM 24. As the HDD 1 starts up, data that is required for control and data processing, in addition to micro-codes that run on the MPU, are loaded to the RAM 24 from the magnetic disk 11 or a ROM (not shown in FIG. 1). The HDC/MPU 23 executes overall control of the HDD 1 in addition to processes that are required for data processing such as positioning control of the head element 12, interface control and defect management. In particular, in the embodiment, the HDC/MPU 23 controls switching between power-save modes to reduce consumption power and the active mode as a normal operating state. Further the description will be made of this point in detail later.

The HDC/MPU 23 transmits data that has been read from the magnetic disk 11 and obtained from the R/W channel 21 to the host 51. The HDD 1 according to the embodiment executes transmission and reception of data (including commands, user data and control data) through serial communication with the host 51. The detailed description will be later made of this point.

Next, power-save mode control and the data transfer with the host associated therewith will be described in the HDD 1 of the embodiment. The HDD 1 of the embodiment executes judgment on approval or disapproval of switching to a power-save mode in a command execution sequence (during execution of the sequence). Approval or disapproval of switching to a power-save mode is judged according to the execution status in the execution sequence, whereby power consumption is reduced and a decrease in performance is prevented.

The power-save mode control according to the present invention is suitable for the HDD 1 of the embodiment which incorporates a serial interface. The HDD 1 according to the embodiment executes transmission and reception of data including commands, user data and control data in a communication protocol through serial data transmission with the host 51. In addition, the HDD 1 according to the embodiment can control power-save modes of the serial interface independently of other circuits. It can also select the serial interface independently of other circuits to switch the serial interface to a power-save mode.

The serial interface is demanded to keep communication so that a link between the host 51 and the HDD 1 can be established, and power consumption will increase in this respect. When data transfer is not conducted between the host 51 and the HDD 1, it is possible to reduce power consumption by switching the serial interface to a power-save mode. In addition, the whole system of the HDD 1 is not switched to the power-save mode, but only the serial interface is switched to the power-save mode. In this case, much time is not required for resetting the mode to the active mode. Consequently, switching made in a command execution sequence will produce less impact to the performance.

The power-save mode control according to the embodiment is suitable particularly for the Serial ATA (SATA) Specification which stipulates a method of transferring data between a data storage device and a host. The SATA Specification stipulates two power-save modes for the serial interface; one mode is the Partial mode, and the other is the Slumber mode. The SATA Specification stipulates time required before these power-save modes are reset, and it does not stipulate configurations of the circuit to be suspended. More specifically, the reset time for the Partial and the Slumber modes is stipulated to be 10 μs and 10 ms, respectively. As stated above, since the power-save mode control according to the embodiment is suitable to SATA, a description will be made hereunder by referring to SATA as an example. It should be noted that the present invention will not be limited to the power-save mode control of a SATA serial interface.

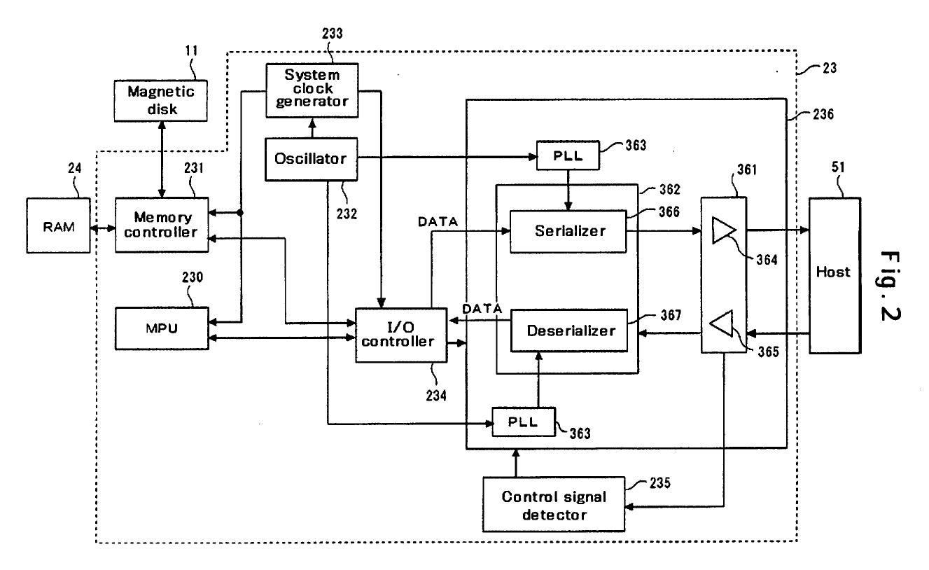

FIG. 2 is a schematic block diagram showing an internal partial circuit configuration of the HDC/MPU 23 of the embodiment. In addition, the magnetic disk 11 and the RAM 24 are shown in FIG. 2. The HDC/MPU 23 includes an MPU 230, a memory controller 231 which controls data transfer to and from the RAM 24, an oscillator 232, a system clock generator 233 which generates a system clock based on a signal from the oscillator 232, an I/O controller 234 which controls communication with the host 51 and controls power-save modes of the interface 236, a control signal detector 235 which detects an out-of-band control signal that is not based on a clock from the host 51, and a serial interface 236 which interfaces serial data transmission with the host 51.

The serial interface 236 includes an analog front-end 361, a serializer/deserializer 362 and a PLL 363. The analog front-end 361 incorporates a transmitter 364 and a receiver 365. The serializer/deserializer 362 includes a serializer 366 which converts parallel data to serial data and output the data to the analog front-end 361 and a deserializer 367 which converts serial data from the analog front-end 361 to parallel data.

The PLL 363 generates a clock signal for serial data communication based on a signal from the oscillator 232 and supplies the signal thus generated to each of the serializer 366 and deserializer 367. The deserializer 367 executes a serial-parallel conversion in accordance with an internal clock signal which is synchronized with a clock signal that is embedded in the serial data received.

In a write process, data from the host 51 (including commands and user data) is received via the receiver 365 by the deserializer 367, by which the data is further serial-parallel converted. Parallel data is input to the I/O controller 234 and is then stored in the RAM 24 via the memory controller 231. User data to be recorded on the magnetic disk 11 is transmitted to the magnetic disk 11 via the memory controller 231.

In a read process, data that has been read from the magnetic disk 11 is stored in the RAM 24 via the memory controller 231. The memory controller 231 reads data recorded in the RAM 24 and transfers the data to the I/O controller 234. The I/O controller 234 transfers the data thus acquired to the serializer 366, and the serializer 366 converts the parallel data acquired into serial data before outputting it to the analog front-end 361. The transmitter 364 outputs the serial data transmitted from the serializer 366 to the host 51. The write and the read processes are executed under the command execution control of the MPU 230.

As stated above, the serial interface 236 includes two power-save modes. In the Partial mode, the serializer/deserializer 362 is put in the inactive status, and the PLL 363 and the analog front-end 361 are put in the active status. In the Slumber mode, the PLL 363 is also put in the inactive status in addition to the serializer/deserializer 362. The analog front-end 361 is in the active status. The Slumber mode consumes less power as compared to the Partial mode, but, on the other hand, the Slumber mode requires longer time for resetting to the active mode. It should be noted that a determination as to which circuit should be suspended in each power-save mode depends on circuit designs.

Switching of the serial interface 236 to a power-save mode is controlled by the I/O controller 234. The serial interface 236 is switched from the active mode to a power-save mode, switched from a power-save mode to the other power-save mode, or switched from a power-save mode to the active mode, as instructed by the I/O controller 234. The power-save mode control executed by the I/O controller 234 will be described in detail later.

When the serial interface 236 has been switched to a power-save mode, data cannot be transmitted or received through serial data transmission based on a clock signal. When the serial interface 236 is in a power-save mode, therefore, the host 51 requests the HDD 1 to make resetting from the power-save mode, by transmitting a control signal (out of band signal) called COMWAKE which is not based on a clock signal. The COMWAKE comprises a plurality of burst signals having a prescribed interval.

The control signal detector 235 detects COMWAKE from the host 51 and, in responding to the COMWAKE, resets the serial interface 236 to the active mode. Switching of the serial interface to a power-save mode is executed in both the host 51 and the HDD 1. More specifically, when the serial interface of the HDD 1 is in a power-save mode, the serial interface of the host 51 has also been switched to a power-save mode. To make a switching request to the active mode from the HDD 1 to the host 51, therefore, a COMWAKE is used as well.

To establish switching to a power-save mode, a mutual approval is necessary between the host 51 and the HDD 1. More specifically, either device can be switched to a power-save mode by taking the steps in which one device transmits a switching request for a power-save mode (called PMREQ in SATA) and the other device returns an approval response to the request (called PMACK in SATA). When the device that received the request does not return an approval response, or in other words, when the device transmits a disapproval response (called PMNACK in SATA) or does not send any response, the device that received the request will not be switched to the power-save mode.

The HDD 1 according to the embodiment judges approval or disapproval of switching to a power-save mode based on the execution process status in an execution sequence of a command. When data transfer between the host 51 and the HDD 1 is scheduled in a short time, it is possible to prevent a decrease in performance by prohibiting switching to the power-save mode. On the other hand, when resetting is made right after completing switching to a power-save mode, it is possible to make the process more efficient by avoiding useless switching, since a reduction in consumption power is not expected in this case.

The HDD 1 according to the embodiment, when receiving a switching request to a power-save mode from the host 51, determines a response to the request based on the execution process status in an execution sequence of a command. Time longer than a certain level is required for switching to a power-save mode and resetting from the power-save mode. In particular, under the status where transfer of user data to or from the host 51 is ready, it is possible to prevent delay in data transfer and decrease in performance by prohibiting switching to a power-save mode. In addition, for a command which does not accompany user data transfer, it is possible to prevent delay in the process by prohibiting switching to a power-save mode until the execution sequence is completed.

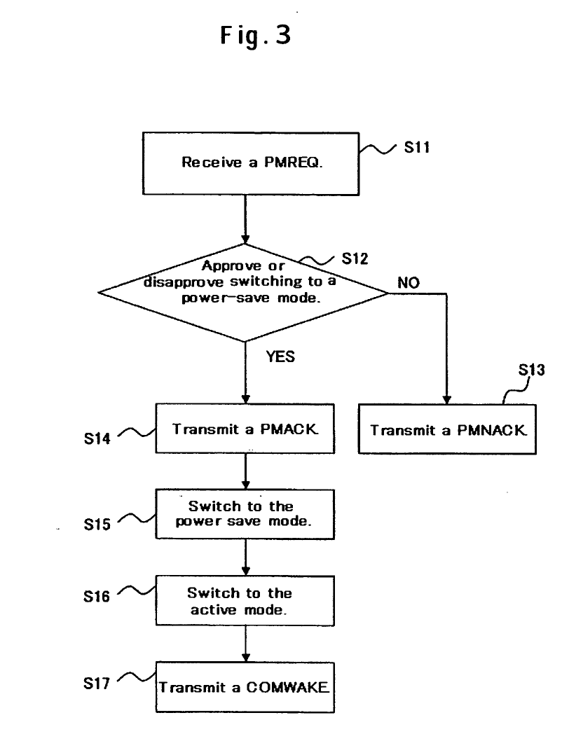

As shown in the flow chart in FIG. 3, the HDD 1, upon receiving a switching request (PMREQ) to a power-save mode from the host 51 (S11), judges as to whether the serial interface 236 should be switched to the power-save mode, based on the execution status of the command (S12). When determining not to execute the switching, the HDD 1 transmits a disapproval response (PMNACK) to the host 51 (S13) and holds the serial interface 236 in the active mode.

On the other hand, when determining to execute the switching to the power-save mode, the HDD 1 transmits an approval response (PMACK) to the host 51 (S14), and the serial interface 236 is switched to the power-save mode (S15). When a request is made by the HDD 1 for resetting to the active mode, the HDD 1 switches the serial interface 236 to the active mode (S16), and further, the HDD 1 requests the host 41 to be switched to the active-mode by transmitting a COMWAKE signal to the host 51 (S17).

Likewise, the HDD 1 according to the embodiment determines whether transmission of a switching request to a power-save mode to the host 51 should be approved or disapproved, based on the execution process status of a command. When data transfer between the host 51 and the HDD 1 is expected in a prescribed process in a short time, it is possible to prevent a decrease in performance by prohibiting making a switching request to the power-save mode. In particular, after the HDD 1 made a data transfer request to a host, the data transfer is anticipated from the host 51 in a short time. It is therefore possible to prevent a decrease in performance by prohibiting switching to a power-save mode during the period of time from a point when the data transfer request is made to a point when the data transfer is executed.

In the embodiment, the /O controller 234 judges whether switching should be made to a power-save mode, that is, it works as a power-save mode controller. The I/O controller 234 acquires necessary information form the MPU 230 and the memory controller 231, judges the execution status of the execution sequence, and judges whether switching to the power-save mode should be approved or disapproved according to the prescribed standards.

When switching to a power-save mode is prohibited, the I/O controller 234 transmits an approval/disapproval response PMACK to the host 51 via the serial interface 236. Likewise, when switching to a power save mode is prohibited, the I/O controller 234 determines not to transmit a switching request to a power-save mode (PMREQ) to the host 51.

On the other hand, when switching to a power-save mode is determined, the I/O controller 234 transmits a PMACK to the host 51 via the serial interface 236, and further, switches the serial interface 236 to a power-save mode. At this time, it is possible to determine whether switching should be made to the Partial mode or the Slumber mode according to the command execution status. For example, while the command execution process is active, the Partial mode which ensures shorter reset time is selected to prevent a decrease in performance. It should be noted that judgment and control of switching to a power-save mode can be executed by the MPU 230 which operates based on a microcode. The judgment and the control operations are-not restricted by a configuration of hardware such as the I/O controller 234, and they can also be incorporated in the form of hardware or software.

Hereinafter, the power-save mode control of the embodiment will be described by taking each of the seven data transfer modes that are specified in the SATA Specifications as an example. More specifically, a description will be made of each of a PIO (Programmed Input Output) data-in command (read), a PIO data-out command (write), a Read DMA (Direct Memory Access) command, a Write DMA command, a Read FPDMA (First Party DMA) Queued command, a Write FPDMA Queued command and a Non-data command.

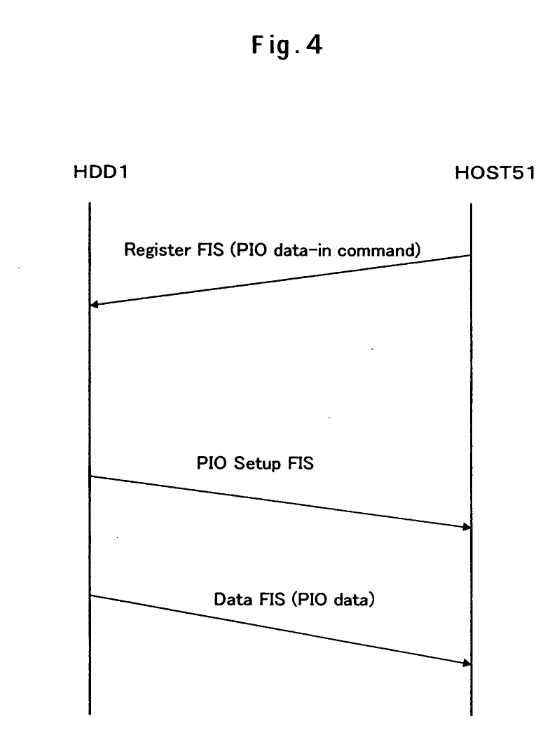

FIG. 4 shows a basic sequence of the PIO data-in command. The PIO data-in command protocol specifies data read in the PIO mode. The host 51 transmits a Register FIS which contains the PIO data-in command to the HDD 1. Referring to SATA, data transfer between the host 51 and the HDD 1 utilizes a data frame called FIS (Frame Information Structure). In addition, a Register FIS is an FIS which is used for command issuing or command completion notification. The HDD 1, in response to the Register FIS, transmits a PIO Setup FIS, which indicates startup of read data transfer, to the host 51. Thereafter, the HDD 1 transmits a PIO data FIS containing read data to the host 51.

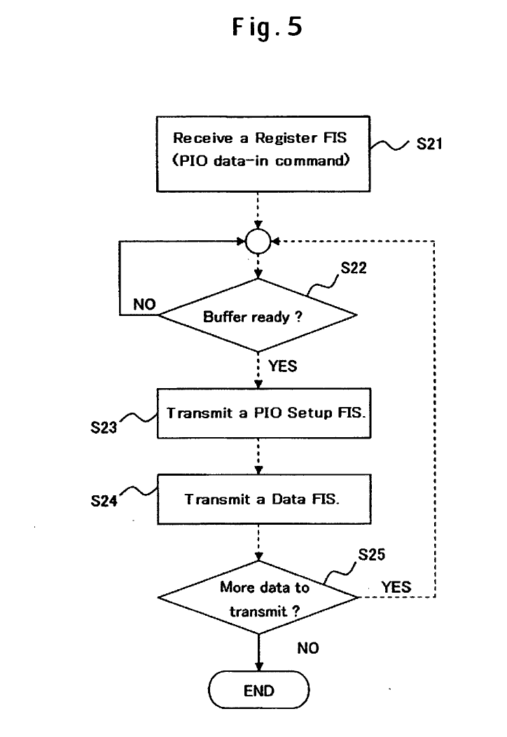

FIG. 5 is a flow chart showing processes in the HDD 1 in an execution sequence of the PIO data-in command. Referring to FIG. 5, the dotted lines show the execution status where switching to a power-save mode is prohibited, and solid lines show the execution status where switching to the power-save mode is permitted. More specifically, in the execution status shown in dotted lines, upon receiving a switching request to a power-save mode (PMREQ) from the host 51, the HDD 1 transmits a disapproval response (PMNACK) to the host 51 in response to the request. In addition, under the execution status, switching to a power-save mode is prohibited in the HDD 1, and the HDD 1 will not transmit the PMREQ to the host 51.

Referring to FIG. 5, upon receiving a Register FIS containing a PIO data-in command (S21), the HDD 1 judges whether data to be transmitted to the host is stored in the buffer (S22). The buffer is secured within the RAM 24. The HDD 1 repeats judging operations until the data to be transmitted becomes ready in the buffer (NO in S22). When the data to be transmitted is ready in the buffer (YES in S22), the HDD 1 transmits a PIO Setup FIS to the host 51 (S23), and thereafter, transmits a Data FIS containing PIO data to the host 51 (S24). Since data transfer is executed for a command by dividing the data into a plurality of FIS's in some cases, the HDD 1 judges whether further read data to be transmitted exists or not (S25). If the read data exist (YES in S25), HDD 1 sets the process back to S21 and repeats subsequent processes. The process completes when transmission of all read data is completed and no data to be transmitted exists (NO in S25).

In the execution sequence of the PIO data-in command, switching to a power-save mode is permitted in the execution status during the period of time from a point when the user data stored in the buffer has been transmitted to a point when the subsequent data to be transmitted is stored in the buffer. Consequently, under the status, when the HDD 1 receives a PMREQ from the host, a PMACK is transmitted to the host 51. However, under other execution statuses, or more specifically, from a point when data to be transmitted is ready in the buffer to a point when transmission of the data to the host is completed, switching to a power-save mode is prohibited. When a PMREQ is received under the status, therefore, a PMNACK is transmitted to the host 51. When the data to be transmitted is stored in the buffer and data transmission becomes ready, the remaining time until the data transmission is short, and therefore, switching to a power-save mode during the period causes delay in data transmission, thus decreasing the performance. Prohibiting switching to a power-save mode makes it possible to prevent a decrease in performance.

Referring to the embodiment, judgment on data storage in the buffer is executed by the I/O controller 234 according to a signal indicating the buffer status from the memory controller 231. The memory controller 231 confirms, following an instruction from the MPU 230, if read data is stored in the buffer, and stores read data from the magnetic disk 11 in the buffer. Upon confirming existence of the read data to be transmitted in the buffer, the memory controller 231 notifies the I/O controller 234 of the storage. The I/O controller 234, in responding to a signal from the memory controller 231, transmits a PIO Setup FIS and a Data FIS to the host 51. In addition, since the I/O controller 234 has already received an instruction from the MPU 230 on the data to be transmitted, the I/O controller 234 can judge whether data that is not transmitted yet exists or not. Accordingly, in the execution sequence of the PIO data-in command, when a PMREQ is received from the host 51, the PMREQ is transmitted to the I/O controller 234 via the serial interface 236, and the I/O controller 234 judges the execution status of the execution sequence to determine approval or disapproval of switching to the power-save mode.

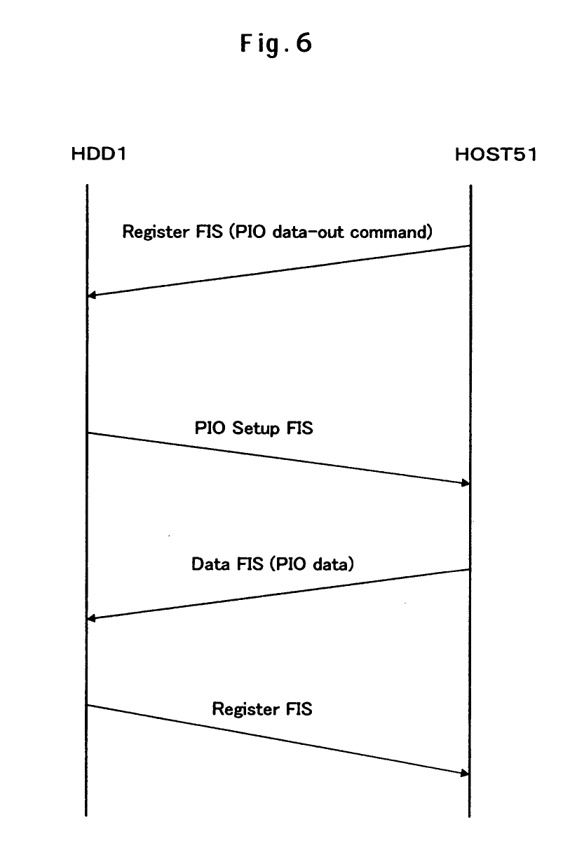

Next, an execution sequence of the PIO data-out command will be described. FIG. 6 shows a basic sequence of the PIO data-out command. The PIO data-out command protocol specifies data write in the PIO mode. The host 51 transmits Register FIS which contains the PIO data-out command to the HDD 1. The HDD 1, in response to the Register FIS containing the PIO data-out command, transmits a PIO Setup FIS, which indicates that reception of the write data is ready, to the host 51. The host 51, upon receiving the PIO Setup FIS, transmits a Data FIS containing write data (PIO data) to the HDD 1. The HDD 1, upon receiving all data and completing command processes, transmits a Register FIS to the host 51 as a completion notification.

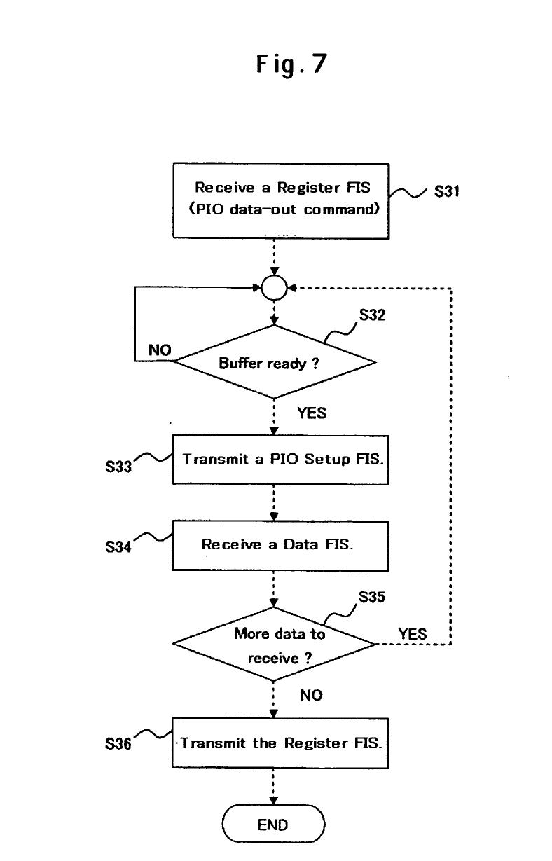

FIG. 7 is a flow chart showing processes in the HDD 1 in an execution sequence of the PIO data-out command. Referring to FIG. 7, as is the case with FIG. 5, switching to a power-save mode is prohibited under the execution status shown in dotted lines. Switching to a power-save mode is permitted under the execution status shown in solid lines. It is to be noted that, in the embodiment, the write cache should be enabled.

Referring to FIG. 7, upon receiving a Register FIS containing the PIO data-out command (S31), the HDD 1 judges if an area adapted to store data to be transmitted from the host is available in the buffer (S32). When a storage area is not secured within the buffer yet, the HDD 1 waits until the storage area is secured (NO in S32). When the storage area is secured within the buffer (YES in S32), the HDD 1 transmits a PIO Setup FIS to the host 51 (S33). The HDD 1 receives a PIO data FIS from the host 51 and stores it in the buffer (S34). If further write data to be received exists (YES in S35), the HDD 1 sets the process back to S32 and repeats subsequent processes. The HDD 1 completes processes, when reception of all write data is completed and no data to be received exists (the dotted line NO in S25), after transmitting the Register FIS (S36).

In the execution sequence of the PIO data-out command, switching to a power-save mode is permitted in the execution status during the period of time from a point when the user data is received and stored in the buffer to a point when an area adapted to store subsequent data is secured in the buffer. However, under other execution statuses, or more specifically, from a point when a free space for storing data to be transmitted to the buffer is secured and data transmission is ready to a point when transmission of the data from the host 51 is completed, switching to a power-save mode is prohibited. With such an arrangement, it is possible to prevent a decrease in performance caused by switching to a power-save mode. Since the I/O controller 234 has already received a signal concerning the buffer status from the memory controller 231, and therefore, the I/O controller 234 can judge if the free space is available in the buffer and determines approval or disapproval of switching to a power-save mode in the execution sequence of the PIO data-out command.

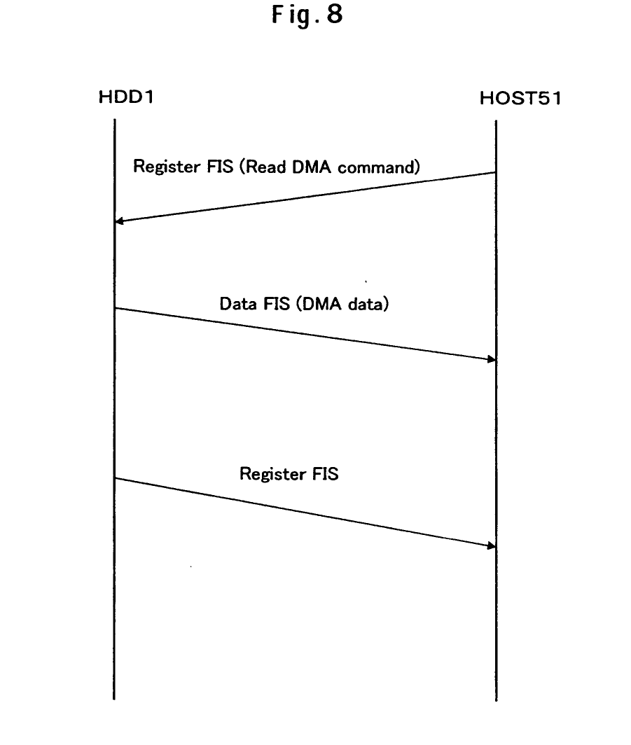

Next, an execution sequence of the Read DMA command will be described. FIG. 8 shows a basic sequence of the Read DMA command. The Read DMA command protocol specifies data read in the DMA mode. The host 51 transmits Register FIS which contains the Read DMA command to the HDD 1. The HDD 1, in response to the Register FIS containing the Read DMA command, transmits a Data FIS containing read data (DMA data) to the host 51. The HDD 1, upon transmitting all data and completing the command processes, transmits a Register FIS to the host 51 as a completion notification.

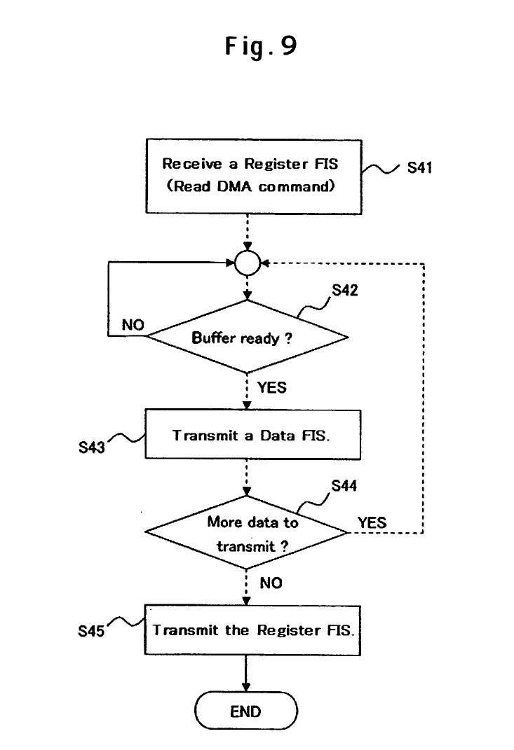

FIG. 9 is a flow chart showing processes in the HDD 1 in an execution sequence of the Read DMA command. Dotted lines and solid lines have the same meanings as those in FIG. 5. Referring to FIG. 9, upon receiving a Register FIS containing the Read DMA command (S41), the HDD 1 judges if data to be transmitted to the host is stored in the buffer (S42). When the data to be transmitted to the host is ready in the buffer (YES in S42), the HDD 1 transmits a Data FIS containing read data (DMA data) PIO data to the host 51 (S43). If further read data to be transmitted exists (YES in S44), the HDD 1 sets the process back to step S42 and repeats subsequent processes. The HDD 1 completes the processes, when transmission of all read data is completed and no data to be transmitted exists (the solid line NO in S25), after transmitting the Register FIS to the host 51 (S45).

In the execution sequence of the Read DMA command, switching to a power-save mode is permitted in the execution status during the period of time from a point when the user data stored in the buffer is transmitted to the point when the subsequent read data for the command is stored in the buffer. However, under other execution statuses, or more specifically, from a point when the data to be transmitted is ready in the buffer to a point when transmission of the data to the host is completed, switching to a power-save mode is prohibited. By prohibiting switching to the power-save mode as stated above, it is possible to prevent a decrease in performance. Note that the description will be here omitted of the specific processes of approval or disapproval of switching to a power-save mode by the I/O controller 234 since the processes are substantially similar to those described above. In the description hereunder, specific operations of the I/O controller 234 will be described to the extent as required.

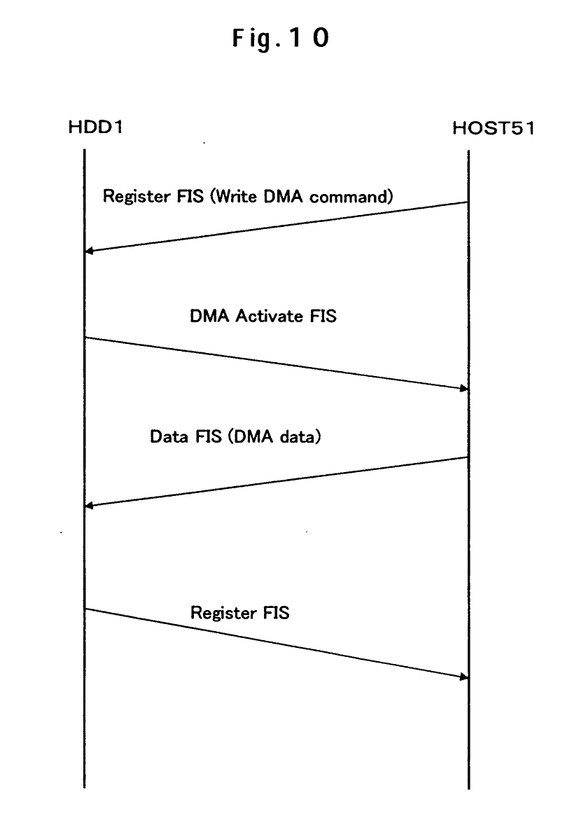

Next, an execution sequence of the Write DMA command will be described. FIG. 10 shows a basic sequence of the Write DMA command. The Write DMA command protocol specifies data write in the DMA mode. The host 51 transmits a Register FIS which contains the Write DMA command to the HDD 1. The HDD 1, in response to the Register FIS containing the Write DMA command, transmits a DMA Activate FIS to the host 51. The host 51, upon receiving the DMA Activate FIS, transmits a Data FIS containing write data (DMA data) to the HDD 1. Upon receiving all data and completing the command processes, the HDD 1 transmits a Register FIS to the host 51 as a completion notification.

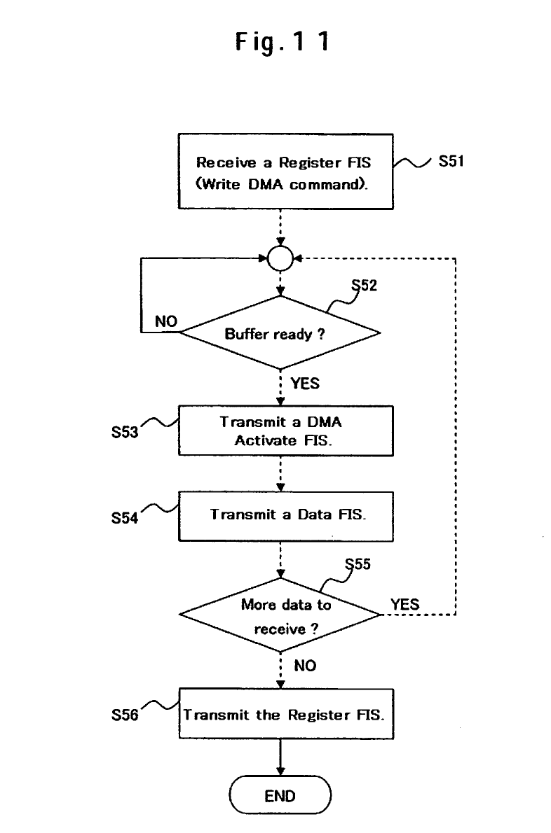

FIG. 11 is a flow chart showing processes in the HDD 1 in an execution sequence of the Write DMA command. Dotted lines and solid lines have the same meanings as those in FIG. 5. Referring to FIG. 11, upon receiving a Register FIS containing the Write DMA command (S51), the HDD 1 judges if a free space for storing data to be transmitted from the host is available in the buffer (S52). When a storage space is secured in the buffer, the HDD 1 transmits a DMA Activate FIS to the host 51 (S53). The HDD receives a Data FIS containing write data from the host 51 (S54) and stores the Data FIS in the buffer. If further write data to be received exists (YES in S55), the HDD 1 sets the process back to step S52 and repeats subsequent processes. The HDD 1 completes the processes, when reception of all write data is completed and no data to be received exists (NO in S55), after transmitting the Register FIS to the host 51 (S56).

In the execution sequence of the Write DMA command, switching to a power-save mode is permitted in the execution status during the period of time from a point when the data to be transmitted from the host 51 is received to the point when an area for storing subsequent data to be transmitted is secured in the buffer. However, under other execution statuses, or more specifically, from a point when a free space adapted to store data to be transmitted is secured in the buffer to a point when the transmission of the data from the host is completed, switching to a power-save mode is prohibited. With such an arrangement, it is possible to prevent a decrease in performance caused by switching to a power-save mode.

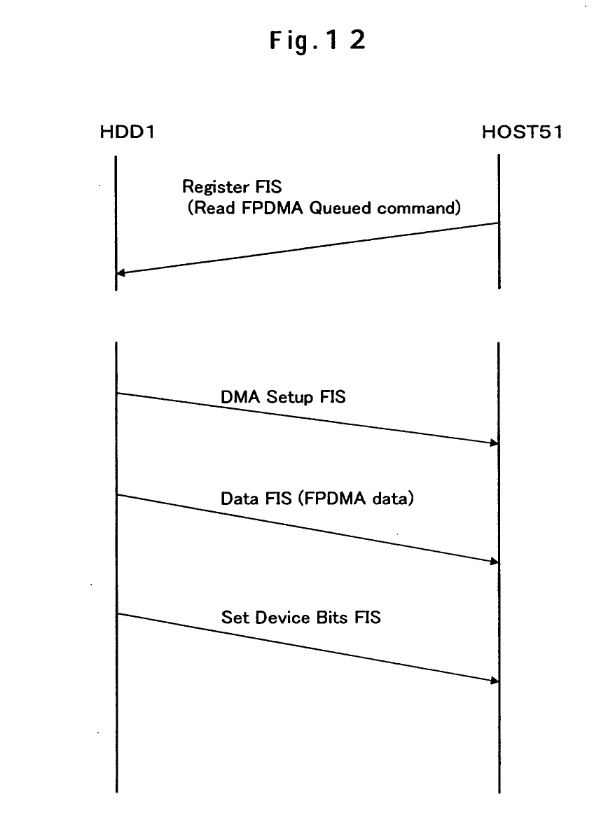

Next, an execution sequence of the Read FPDMA Queued command will be described. FIG. 12 shows a basic sequence of the Read FPDMA Queued command. Since the Read FPDMA Queued command protocol utilizes command queuing, issuance and execution of commands are separated, and therefore, the issuing order and execution order of commands do not always coincide with each other. The host 51 transmits a Register FIS which contains the Read FPDMA Queued command to the HDD 1. The HDD 1 queues the Read FPDMA Queued command received.

In the step where a Read FPDMA Queued command that has been queued is executed, the HDD 1 transmits a DMA Setup FIS which indicates startup of a data transmission process for the Read FPDMA Queued command to the host 51. Thereafter, the HDD 1 transmits a Data FIS containing FPDMA data to the host 51. Upon transmitting all data and completing the command processes, the HDD 1 transmits a Set Device Bits FIS as a completion notification to the host 51. A flag associated with the Read FPDMA Queued command in the host 51 is cleared by the Set Device Bits FIS, thus enabling the host 51 to issue a new command. It should be noted that, when data is divided into a plurality of Data FIS's for transfer, the HDD 1 will transmit a DMA Setup FIS before transmitting the first Data FIS, and thereafter, the HDD 1 will transmit a Data FIS without transmitting the DMA Setup FIS.

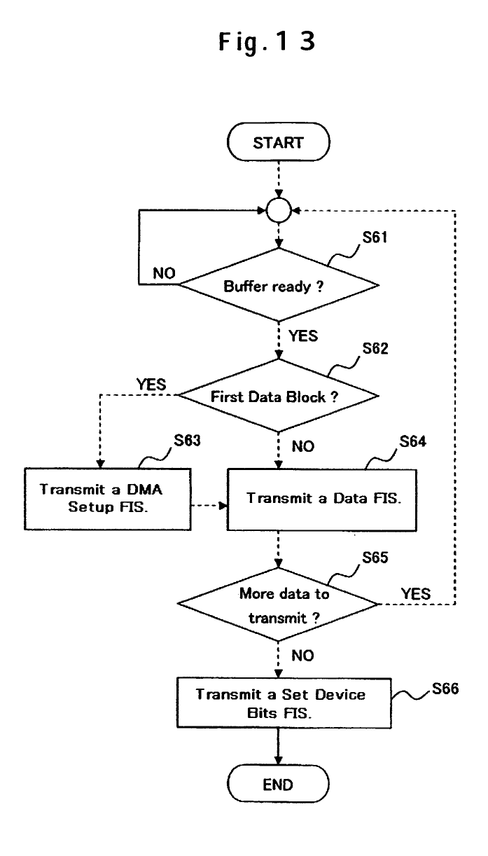

Referring to FIG. 13, processes in the HDD 1 in an execution sequence of the Read FPDMA Queued command will be described. FIG. 13 shows processes for executing data service after queuing a command. Dotted lines and solid lines have the same meanings as those in FIG. 5. When execution of data service of the Read FPDMA Queued command that has been queued is initiated, the HDD 1 judges if data to be transmitted to the host is stored in the buffer (S61). When the data to be transmitted is ready in the buffer (YES in S61) and the data to be transferred is the first block (Data FIS) (YES in S62), the HDD 1 transmits a DMA Setup FIS to the host 51 (S63).

Further, the HDD 1 transmits a Data FIS containing read data (FPDMA data) to the host 51 (S64). Furthermore, when read data to be transmitted exists (YES in S65), the HDD 1 sets the process back to step S61 and repeats subsequent processes. Note that, however, the DMA Setup FIS will not be transmitted before the second and later Data FIS is transmitted (NO in S62). When transmission of all read data is completed and no data to be transmitted exists any more (the dotted line NO in S65), the HDD 1 transmits a Set Device Bits FIS to the host 51 (S66), completing the processes. It should be noted that the DMA Setup FIS and the Set Device Bits FIS are generated and are transmitted to the host 51 by the I/O controller 234.

In the execution sequence of the Read FPDMA Queued command, switching to a power-save mode is permitted in the following execution status. Specifically, this status is during the period of time from a point when execution of data service of the Read FPDMA Queued command that has been queued is initiated and the read data stored in the buffer is transmitted to the point when the subsequent read data for the command is stored in the buffer. However, under other execution statuses, or more specifically, from a point when data to be transmitted is ready in the buffer to a point when transmission of the data to the host is completed, switching to a power-save mode is prohibited. By prohibiting switching to a power-save mode as stated above, it is possible to prevent a decrease in performance.

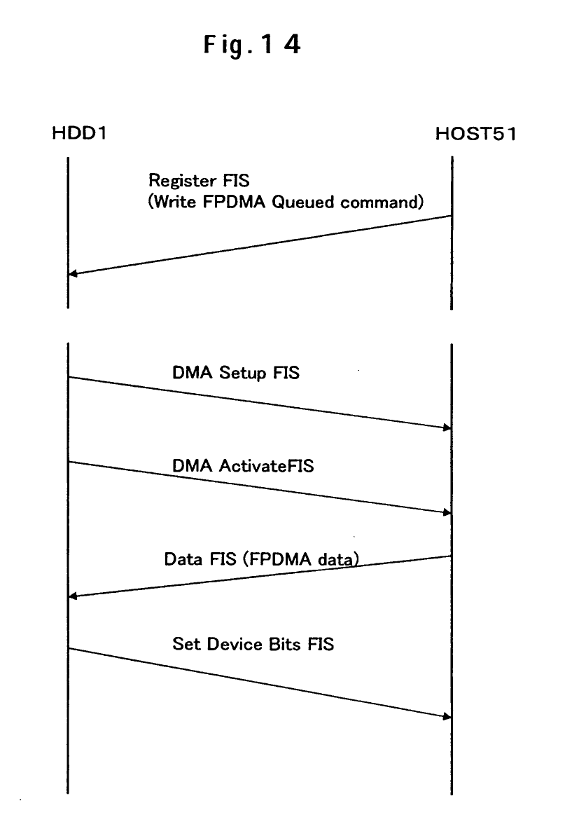

Next, an execution sequence of the Write FPDMA Queued command will be described. FIG. 14 shows a basic sequence of the Write FPDMA Queued command. Since the Write FPDMA Queued command protocol utilizes command queuing, the issuance and execution of commands are separated from each other; therefore, the issuing order and execution order of commands do not always coincide with each other. The host 51 transmits a Register FIS which contains the Write FPDMA Queued command to the HDD 1. The HDD 1 queues the Write FPDMA Queued command received.

In the step where a Write FPDMA Queued command that has been queued is executed, the HDD 1 transmits a DMA Setup FIS which indicates startup of a data transmission process for the Write FPDMA Queued command to the host 51. Thereafter, the HDD 1 transmits a DMA Activate FIS requesting for data transmission to the host 51. Upon receiving the DMA Activate FIS, the host 51 transmits a Data FIS containing write data (FPDMA data) to the HDD 1. Upon receiving all data and completing command processes, the HDD 1 transmits a Set Device Bits FIS to the host 51 as a completion notification. It should be noted that, when data is divided into a plurality of Data FIS's for transfer, the HDD 1 will transmit a DMA Setup FIS before transmitting the first Data FIS, and thereafter, the HDD 1 will transmit a Data FIS without transmitting the DMA Setup FIS.

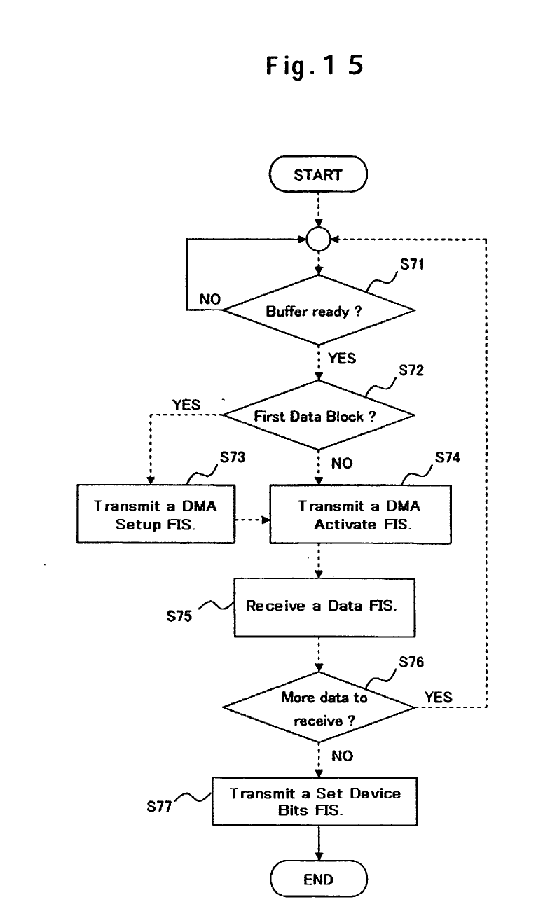

FIG. 15 is a flow chart showing processes in the HDD 1 in an execution sequence of the Write FPDMA command. Dotted lines and solid lines have the same meanings as those in FIG. 5. FIG. 15 shows processes for executing data service after queuing a command. When execution of data service of the Write FPDMA Queued command that has been queued is initiated, the HDD 1 judges if an area adapted to store data to be transmitted from the host is available in the buffer (S71). When a storage area is secured within the buffer (YES in S71), and if the data to be transmitted is the first block (Data FIS)(YES in S72), the HDD 1 transmits a DMA Setup FIS to the host 51 (S73). Further, the HDD 1 transmits a DMA Setup FIS to the host 51 (S74). The HDD 1 receives a Data FIS containing write data from the host 51 (S75) and stores the Data FIS in the buffer. When more write data to be received exists (YES in S76), the HDD 1 sets the process back to step S71 and repeats subsequent processes. Note that, however, in the process before transmitting the second or later Data FIS, the HDD 1 does not transmit the DMA Setup FIS, but it transmits only the DMA Activate FIS (NO in S72). When reception of all write data is completed, that is, no data to be received exists any more (NO in S76), the HDD 1 transmits a Set Device Bits FIS to the host 51 (S77), completing the processes.

In the execution sequence of the Write FPDMA Queued command, switching to a power-save mode is permitted in the following status. This status is during the period of time from a point when execution of data service of the Write FPDMA Queued command that has been queued is initiated and the data transmitted from the host 51 is received and stored in the buffer to the point when an area adapted to store the subsequent data to be transmitted is secured in the buffer. However, under other execution statuses, or more specifically, from a point when an area adapted to store the subsequent data is secured in the buffer to a point when transmission of the data from the host is completed, switching to a power-save mode is prohibited. By prohibiting switching to a power-save mode as stated above, it is possible to prevent a decrease in performance.

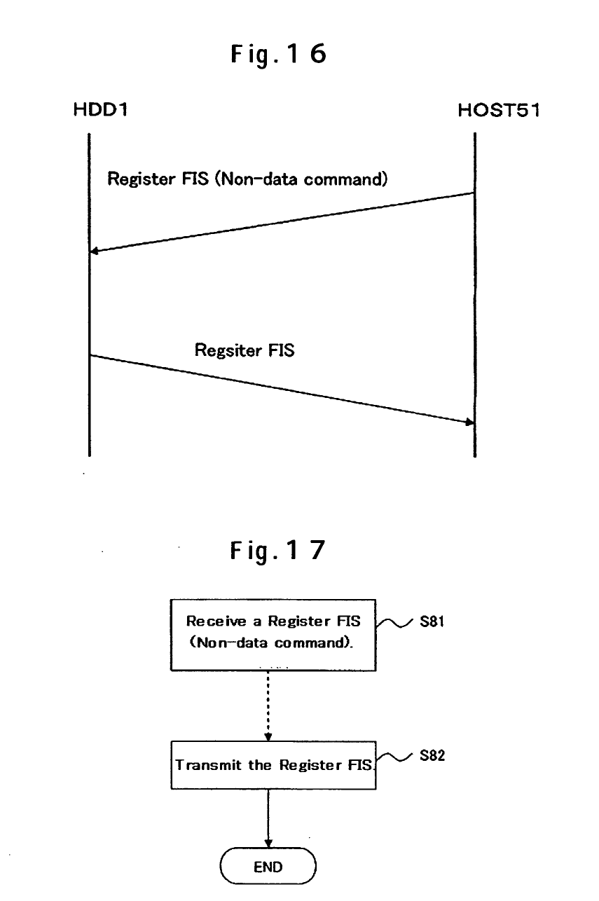

Finally, an execution sequence of a Non-data command, such as Seek, Recal and Verify, which does not execute transmission or reception of user data between the host 51 and the HDD 1 will be described. FIG. 16 shows a basic sequence of the Non-data command. The host 51 transmits a Register FIS containing the Non-data command to the HDD 1. The HDD 1 transmits a Register FIS to the host 51 as a completion notification when completing processes associating with the Non-data command. FIG. 17 is a flow chart showing processes in the HDD 1 in an execution sequence of the Non-data command. Dotted lines and solid lines have the same meanings as those in FIG. 5. Upon receiving a Register FIS (S81), the HDD 1 executes associating processes and transmits a Register FIS to the host 51 as a result of the execution completion (S82). Switching to a power-save mode is prohibited under the status from a point when the non-data command is received to a point when processes are executed and the Register FIS is transmitted to the host 51. By prohibiting switching to a power-save mode as stated above, it is possible to prevent a decrease in performance.

The description stated above is made just to explain embodiments according to the present invention, and therefore, the present invention is not limited to the above-stated embodiments. It is understood by those skilled in the art that elements of the foregoing embodiments can be easily changed, added or modified without departing from the spirit and scope thereof. For example, the present invention is not limited to the SATA protocol. The present invention is not limited to the power-save mode control of the interface. Further, the relationship between each process and the logical composition is not limited to the above-described examples. Designers can design data storage devices by utilizing effective functions and circuit configurations. In the embodiments, the head element 12 is a read/write head which is capable of executing writing and reading processes, but the present invention is also applicable to a read-only device which is designed for detachable recording medium and dedicated for data reading. It should be noted that the present invention is particularly useful for data storage devices of other types, but it is also applicable to other modes of data storage devices which drive recording media, including optical disk storage devices which are designed for detachable optical disks such as CDs, and data storage devices using semiconductor recording medium.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A control method for a power-save mode of a data storage device, said control method comprising:
receiving from a host a request for switching to a power-save mode;
judging an execution status in a command execution sequence in responding to said request from said host for switching;
determining approval or disapproval of said request based on said command execution status that is obtained in said judgment; and
transmitting said determined approval or disapproval to said host.

2. A control method for a power-save mode according to claim 1,
wherein said data storage device executes data communications through serial data transmission with said host and is capable of switching a serial interface to a power-save mode independently of other circuits in said data storage device; and
said request is a request for switching to a power-save mode of said serial interface.

3. A control method for a power-save mode according to claim 1,
wherein, in an execution sequence of a command not accompanying user data transfer, when said request for switching to a power-save mode is received, a disapproval response to said request is transmitted to said host.

4. A control method for a power-save mode according to claim 1,
wherein, in an execution sequence of a read command accompanying user data transfer to said host, when said request is received during a period of time from a point when said user data to be transmitted is stored in a buffer to a point when said user data is transmitted to the host, a disapproval response to said request is transmitted to said host.

5. A control method for a power-save mode according to claim 4,
wherein, when said request is received during a period of time from a point when said user data is transmitted to a point when an area adapted to store subsequent user data associating with said active read command is secured in said buffer, an approval response to said request is transmitted to said host and switching to a power-save mode is executed.

6. A control method for a power-save mode according to claim 1,
wherein, when user data transfer to said host is ready, a disapproval response to said request is transmitted to said host.

7. A control method for a power-save mode according to claim 1,
wherein, in an execution sequence of a write command accompanying reception of user data from said host, when said request is received during a period of time from a point when an area adapted to store said user data to be received is secured in a buffer to a point when said user data is received from said host, said controller determines approval or disapproval of said request.

8. A data storage device, comprising:
a receiver which receives from a host a request for switching to a power-save mode;
a controller which, in responding to said request from said host, judges execution status in a command execution sequence and determines approval or disapproval of said request based on said command execution status thus judged; and
a transmitter which transmits a response of said determined approval or disapproval to said host.

9. A data storage device according to claim 8, further comprising a serial interface which is adaptable to execute data communications through serial data transmission with said host, and which can be switched to a power-save mode independently of other circuits in said data storage device;
wherein said request for switching to a power-save mode is a request for switching to a power-save mode of said serial interface.

10. A data storage device according to claim 8,
wherein, in an execution sequence of a write command accompanying reception of user data from said host, when said request is received during a period of time from a point when an area adapted to store said user data to be received is secured in a buffer to a point when said user data is received from said host, said controller determines approval or disapproval of said request.

11. A data storage device according to claim 10,
wherein, when said request is received during a period of time from a point when said user data is stored in said buffer to a point when an area adapted to store subsequent user data associating with said active write command is secured in said buffer, said controller determines approval to said request.

12. A data storage device for a power-save mode according to claim 8,
wherein, in an execution sequence of a command not accompanying user data transfer, when said request for switching to a power-save mode is received, a disapproval response to said request is transmitted to said host.

13. A data storage device for a power-save mode according to claim 8,
wherein, in an execution sequence of a read command accompanying user data transfer to said host, when said request is received during a period of time from a point when said user data to be transmitted is stored in a buffer to a point when said user data is transmitted to the host, a disapproval response to said request is transmitted to said host.

14. A data storage device for a power-save mode according to claim 8,
wherein, when user data transfer to said host is ready, a disapproval response to said request is transmitted to said host.

15. A data storage device which includes a mode to execute regular operations and a power-save mode, comprising:
a controller which judges execution status in a command execution sequence after initiating execution of a command and judges approval or disapproval of switching to the power-save mode based on said command execution status thus judged; and
a communication interface with a host, which is switched to the power-save mode when said controller determines approval for the switching.

16. A data storage device according to claim 15,
wherein said controller judges execution status in a command execution sequence in responding to a request from a host for switching to a power-save mode and determines approval or disapproval of said request for approval based on said command execution status thus judged; and
said communication interface transmits a response associating with said determination to said host.

17. A data storage device according to claim 16,
wherein said controller, when receiving said request for switching in an execution sequence of a command not accompanying user data transfer, determines disapproval to said request.

18. A data storage device according to claim 16,
wherein, in an execution sequence of a read command accompanying transmission of user data to said host, when receiving said request for switching during a period of time from a point when said user data to be transmitted is stored in a buffer to a point when said user data is transmitted to said host, said controller determines disapproval to said request.

19. A data storage device according to claim 18,
wherein, when receiving said request for switching during a period of time from a point when said user data is transmitted to a point when an area adapted to store subsequent user data associating with said active read command in said buffer, said controller determines approval to said request, and said communication interface is switched to the power-save mode.

20. A data storage device according to claim 15,
wherein, said communication interface transmits a request for data transfer to said host in an execution sequence of a write command; and
said controller disapproves transmission of a request for switching to the power-save mode to said host during a period of time from a point when said request is transmitted to a point when data associating with said request is received from said host.
